(19) United States
(12) Patent Application Publication
(10) Pub. No.: US 2011/0109151 A1
(43) Pub. Date: May 12, 2011

(54) CAST AXLE STUB WITH A CAST-IN STEEL CORE PROCESS FOR PRODUCING THE AXLE STUB

(76) Inventor: Karl Seidinger, Volkertshausen (DE)

(21) Appl. No.: 12/942,602

(22) Filed: Nov. 9, 2010

(30) Foreign Application Priority Data
Nov. 10, 2009 (EP) 09175504.1

(51) Int. Cl. B60B 35/04; B22D 19/00

(52) U.S. Cl. 301/131; 164/98

(57) ABSTRACT

An axle stub and to a process for producing the axle stub, consisting of a steel core (which can also be hollow) and a cast part which surrounds the steel core.

### BACKGROUND OF THE INVENTION

The invention relates to a cast axle stub with a cast-in steel core (composite casting) and to a process for producing the axle stub.

In the prior art, the axle stubs of commercial vehicles are formed as steel forgings. The journals are used to receive a wheel bearing, the wheel hub, the brake disc and the wheel.

DE 2349731 describes a hinged part, in particular a front-wheel suspension system for vehicles, and a process for producing it. The hinged arrangement comprises two basic components, specifically a basic cast part and a single-part axle. The single-part axle is formed as a forged part.

The advantage of steel-forged axle stubs is, in particular, the high strength combined with a relatively high elongation at rupture. The disadvantages lie in the high weight and a lack of creative freedom of the designer in shaping, such as hollow bodies, undercuts, etc., which in turn lead to increased production and machining costs. In addition, the corrosion behaviour is better for cast iron than for steel.

The object of the present invention is therefore to propose axle stubs which are less expensive to produce and have a lower weight than the known axle stubs for the required high strength demands.

### SUMMARY OF THE INVENTION

The foregoing object is achieved by the composite cast axle stub according to the invention to be distinguished by greater deformation of the bearing journal in the event of excessive loading.

The composite axle stub is distinguished by the fact that it fails with a delay rather than abruptly after it is damaged (incipient cracking), combined with a relatively high deflection. The driver is therefore able to notice the damage in good time and counter total failure.

According to the invention, the object is achieved by providing an axle stub which is made of a spheroidal cast alloy, wherein the axle region of the axle stub has a solid or hollow steel journal in the inner region. The object is further achieved by providing a process for producing the axle stub which comprises the following steps:

a steel journal is produced;

the steel journal is injected into a sand core;

the core which contains the steel journal is placed into a sand casting mould;

the casting mould is decanted by means of a spheroidal cast alloy; the cast axle stub is shaken out and cleaned.

### BRIEF DESCRIPTION OF THE DRAWINGS

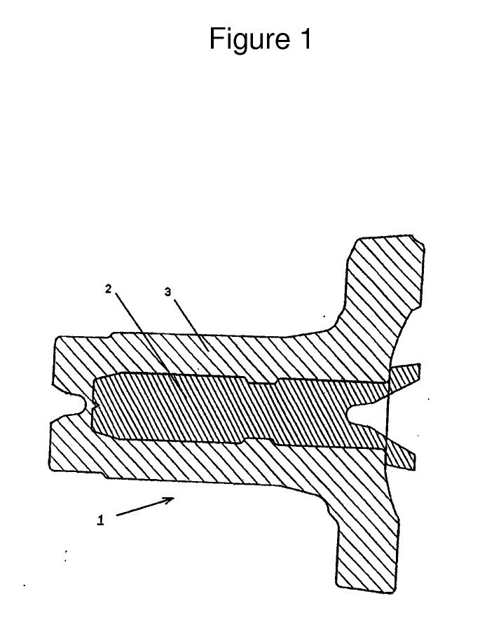

The invention is further described with regard to FIG. 1. FIG. 1 is a sectional illustration showing a possible embodiment of an axle stub 1 according to the invention, with the steel core 2 and the cast part 3 which has been cast around the steel core. The steel core 2 consists of a commercial steel and the cast part 3 consists of a spheroidal cast alloy.

### DETAILED DESCRIPTION

The parts which have been cast from spheroidal cast alloys preferably have, in addition to great mechanical strengths of 500 to 850 MPa, high yield strengths of 350 to 550 MPa and, at the same time, high degrees of ductility of up to 12%.

Furthermore, according to a particular refinement of the invention, the spheroidal cast alloy contains not only the main component Fe but also the non-iron constituents C, Si, P, Mg, Cr, Al, S, Cu and Mn with the conventional impurities, according to the following examples:

### Example 1

The chemical composition is 3.34% by weight C, 2.92% by weight Si, 0.62% by weight Cu, 0.17% by weight Mn, 0.038% by weight Mg, 0.025% by weight P, 0.021% by weight Cr, 0.01% by weight Al, 0.001% by weight S, remainder Fe and the conventional impurities. The number of spherulites is 400 spherulites per mm². The graphite content is 9.7%. The graphite form in accordance with DIN EN ISO 945 is 97.9% of the form VI. The size distribution in accordance with DIN EN ISO 945 is 45% of size 8, 42% of size 7 and 13% of size 6. The pearlite content is 84%. The Brinell hardness is 248 HB. In the tensile test, the following values were established: yield strength Rₚ0.2=474 MPa, tensile strength Rm=778 MPa, elongation at rupture A5 up to 11.4% and modulus of elasticity E=165 to 170 kN/mm².

### Example 2

The chemical composition is 3.5% by weight C, 2.65% by weight Si, 0.77% by weight Cu, 0.26% by weight Mn, 0.038% by weight Mg, 0.026% by weight P, 0.029% by weight Cr, 0.004% by weight Al, 0.001% by weight S, remainder Fe and the conventional impurities. In the tensile test, the following values were established: yield strength Rₚ0.2=405 MPa, tensile strength Rm=639 MPa, elongation at rupture A5 up to 9.6% and modulus of elasticity E=165 to 170 kN/mm². The Brinell hardness is 238 HB.

### Example 3

The chemical composition is 3.43% by weight C, 3.38% by weight Si, 0.71% by weight Cu, 0.2% by weight Mn, 0.037% by weight Mg, 0.047% by weight P, 0.043% by weight Cr, 0.012% by weight Al, 0.004% by weight 5 and 0.0008% by weight B, remainder Fe and the conventional impurities. In the tensile test, the following values were established: yield strength Rₚ0.2=558 MPa, tensile strength Rm=862 MPa and elongation at rupture A5 up to 6.1%. The Brinell hardness is 288 HB. The number of spherulites in the microstructure was determined as 455 spherulites per mm².

An example of an axle stub is shown in the single FIGURE.

The advantages associated with the invention are, in particular, that the axle stub can be produced at lower cost compared to the known solution by forging. It is distinguished by a reduced weight. In addition, the machining is improved considerably.

Since two materials are combined in one component, the main advantages of each individual material are utilized optimally in the bearing journal which is subjected to high levels of loading. High strength on the outside, high elongation on the inside.

The composite casting effects advantageous stress distribution (modulus of elasticity) and thereby increases the service life of the bearing journal which is loaded to reverse bending.

Owing to the composite casting, delayed component failure rather than abrupt component failure occurs in the event of excessive loading, with correspondingly high deformation of the bearing journal. This makes it possible to detect the initial damage and to prevent total failure.

The steel insert has a very positive effect on the cooling conditions and the microstructure formation of the cast material. A very fine-grained pearlite/ferrite microstructure with a high number of spherulites is formed.

The outer side of the steel insert may be coated before it is inserted. The coating may be applied by chemical deposition, for example phosphatizing.

1-5. (canceled)

6. An axle stub comprising:
an axle region comprising a steel journal; and
a casting part formed of a spheroidal cast alloy cast around the axle region.

7. An axle stub according to claim 6, wherein the steel journal is hollow.

8. An axle stub according to claim 6, wherein the steel journal is solid.

9. An axle stub according to claim 6, wherein the spheroidal cast alloy has a tensile strength of between 500 to 850 MPa, a yield strength of between 350 to 550 MPa, and an elongation at rupture of up to 12%.

10. A process for producing an axle stub comprising the steps of:
providing a steel journal;
locating the steel journal in a sand core;
placing the sand core into a sand casting mold;
casting a spheroidal alloy into the casting mold, around the steel journal; and
removing a cast axle stub comprising an axle region comprising a steel journal and a casting part formed of the spheroidal cast alloy cast around the axle region.

11. A process according to claim 10, wherein the steel journal is hollow.

12. A process according to claim 10, wherein the steel journal is solid.

13. A process according to claim 10, wherein the spheroidal cast alloy has a tensile strength of between 500 to 850 MPa, a yield strength of between 350 to 550 MPa, and an elongation at rupture of up to 12%.
